(19) United States
(12) Patent Application Publication
(10) Pub. No.: US 2010/0094860 A1
(43) Pub. Date: Apr. 15, 2010

(54) INDEXING ONLINE ADVERTISEMENTS

(75) Inventors: Wayne W. Lin, San Francisco, CA (US); Matthew S. Weaver, Bellevue, WA (US); Eran Timor, Haifa (IL); Tal Cohen, Atlit (IL); Nicholas S. Arini, Botley (GB); Theodore Vassilakis, Kirkland, WA (US)

Correspondence Address: GOOGLE;Lerner, David, Littenberg, Krumholz & Mentlik, LLP, 600 South Avenue West, Westfield, NJ, 07090, US

(73) Assignee: Google Inc., Mountain View, CA (US)

(21) Appl. No.: 12/248,645

(22) Filed: Oct. 9, 2008

(51) Int. Cl. G06F 17/40; G06Q 30/00; G06F 7/06; G06F 17/30

(52) U.S. Cl. 707/709; 707/E17.11; 707/E17.055; 707/E17.05; 705/14.73; 707/999.107; 707/804

(57) ABSTRACT

In one embodiment, a method for a detection server in communication with each of multiple web pages of multiple websites on multiple web servers, the detection server in communication with an ad indexing server, includes automatically accessing from the detection server a file for rendering the web page from a web server, automatically building an object model of the web page at the detection server using the accessed file, automatically scanning the object model at the detection server for one or more elements that are advertisements, automatically analyzing each scanned advertisement at the detection server to determine one or more attributes of the scanned advertisement, and automatically storing data at the ad indexing server on the determined attributes of the scanned advertisements found at the detection server to facilitate an indexing of advertisements on the web pages of the websites.

### TECHNICAL FIELD

This disclosure relates generally to online advertising.

### BACKGROUND

Online advertising tools provide information about websites (or publishers) and their users to facilitate more effective planning and management of online advertising by advertisers. For example, particular online advertising tools provide anonymized information about the demographics (such as age, gender, education, income, etc.) and anonymized online transactions (such as other visited websites) of users of various websites, as well as information about the number of unique visitors each of the websites has, the country reach of the website, and the number of page views the website receives. Information about online advertisements (such as format, size, and source) at various websites would be similarly useful to advertisers. The more comprehensive and the more detailed the information about the online advertisements, the more useful the information would be to advertisers.

### BRIEF DESCRIPTION OF THE DRAWINGS

FIG. 1 illustrates an example system for indexing online advertisements;

FIG. 2 illustrates an example Document Object Model (DOM) tree;

FIG. 3 illustrates an example architecture for an example computer system; and

FIG. 4 illustrates an example method for indexing online advertisements.

### DESCRIPTION OF EXAMPLE EMBODIMENTS

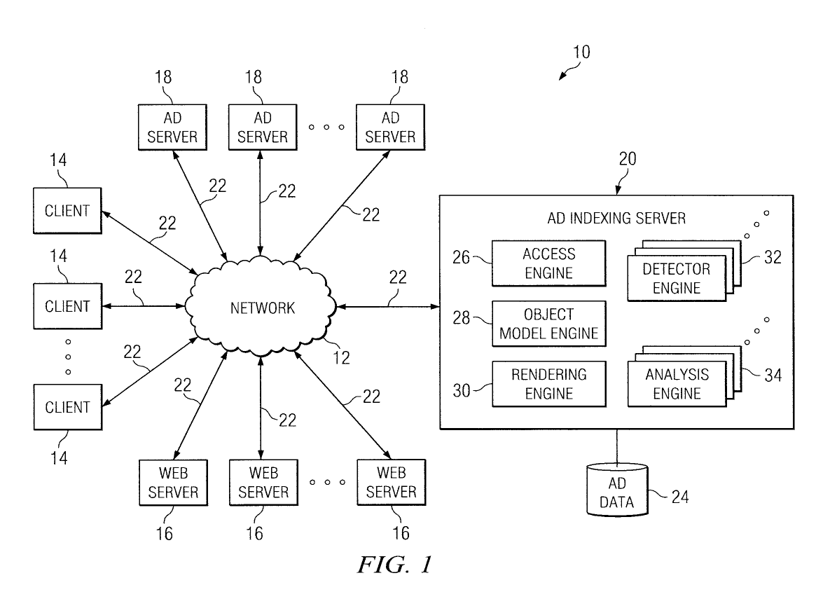

FIG. 1 illustrates an example system 10 for indexing online advertisements. System 10 includes a network 12 coupling one or more clients 14, one or more web servers 16, one or more advertisement (or ad) servers 18, and an ad indexing server 20 to each other. Each server may be a unitary server or may be a distributed server spanning multiple computers or multiple datacenters. In particular embodiments, network 12 is an intranet, an extranet, a virtual private network (VPN), a local area network (LAN), a wireless LAN (WLAN), a wide area network (WAN), a metropolitan area network (MAN), a portion of the Internet, or another network 12 or a combination of two or more such networks 12. The present disclosure contemplates any suitable network 12. One or more links 22 couple a client 14, a web server 16, an ad server 18, or ad indexing server 20 to network 12. In particular embodiments, one or more links 22 each include one or more wireline, wireless, or optical links 22. In particular embodiments, one or more links 22 each include an intranet, an extranet, a VPN, a LAN, a WLAN, a WAN, a MAN, a portion of the Internet, or another link 22 or a combination of two or more such links 22. The present disclosure contemplates any suitable links 22 coupling clients 14, web servers 16, application server 18, and ad indexing server 20 to network 12.

In particular embodiments, a client 14 enables a user at client 14 to access web pages hosted by web servers 16. As an example and not by way of limitation, a client 14 may be a desktop computer system, a notebook computer system, or a mobile telephone having a web browser, such as MICROSOFT INTERNET EXPLORER, GOOGLE CHROME or MOZILLA FIREFOX, which, for example, may have one or more add-ons, plug-ins, or other extensions, such as GOOGLE TOOLBAR. The present disclosure contemplates any suitable clients 14. A user at client 14 may enter a Uniform Resource Locator (URL) or other address directing the web browser to a web server 16, and the web browser may generate a Hyper Text Transfer Protocol (HTTP) request and communicate the HTTP request to web server 16. Web server 16 may accept the HTTP request and communicate to client 14 one or more Hyper Text Markup Language (HTML) files responsive to the HTTP request. Client 14 may render a web page from the HTML files from web server 16 for presentation to the user. The present disclosure contemplates any suitable web page files. As an example and not by way of limitation, web pages may render from HTML files, Extensible HyperText Markup Language (XHTML) files, or Extensible Markup Language (XML) files, according to particular needs. Such pages may also execute scripts such as, for example and not by way of limitation, those written in JAVASCRIPT, JAVA, MICROSOFT SILVERLIGHT, combinations of markup language and scripts such as AJAX (Asynchronous JAVASCRIPT and XML, and the like. Herein, reference to a web page encompasses one or more corresponding web page files (which a browser may use to render the web page) and vice versa, where appropriate.

The present disclosure contemplates any suitable web pages. As an example and not by way of limitation, web pages hosted by web servers 16 may be static or dynamic. In particular embodiments, multiple web pages stored together in a common directory at a web server 16 make up a website or a portion of a website. Herein, reference to a publisher may encompass one or more websites published by the publisher, and vice versa, where appropriate. In particular embodiments, a web page includes one or more elements. As an example and not by way of limitation, presented (or rendered) elements of a web page may include static text, static images, animated images, audio, video, interactive text, interactive illustrations, buttons, hyperlinks, or forms. Such elements may each occupy a particular space on the web page when displayed. Internal (or hidden) elements of a web page may include, for example and not by way of limitation, comments, meta elements, databases, diagramation and style information, and scripts, such as JAVASCRIPT. One or more elements of a web page may be inline frames (IFrames) which enable web developers to embed HTML documents into other HTML documents. Herein, reference to a document may encompass a web page, where appropriate. Reference to an element of a web page may encompass one or more portions of a web page file for rendering the element, and vice versa, where appropriate.

One or more elements of a web page may be advertisements. In particular embodiments, an advertisement has various attributes. As an example and not by way of limitation, attributes of an advertisement may include format (such as text, image, video, audio, animation, gadget, etc.); size; web page position (such as top, left, above the fold, below the fold, etc.); inclusion method (such as being included in the HTML file for the web page, being in an IFrame in the HTML file, or being rendered by execution of a script); presentation mode (such as inline, pop-up, pop-under, pre-roll, etc.); destination landing page URL; ad server (such as DOUBLECLICK DART for ADVERTISERS or GOOGLE ADWORDS); expected click-through rate (eCTR); an ad quality score; one or more targeted keywords and/or one or more targeted publishers; and advertiser. Online advertising campaigns (which may encompass multiple advertisements at multiple publishers) may have similar attributes. As described below, particular embodiments collect information about advertisements, such as their attributes, for use by advertisers in the planning and management of their online advertising. Particular embodiments similarly collect information about online advertising campaigns.

In particular embodiments, a web server 16 includes one or more servers or other computer systems for hosting web pages or particular elements of web pages. The present disclosure contemplates any suitable web servers 16. As described above, a web server 16 may host HTML files or other file types, or may dynamically create or constitute files upon a request, and communicate them to clients 14 in response to HTTP or other requests from clients 14. In particular embodiments, a web browser at a client 14 may render a web page from one or more HTML files received from one or more web servers 16. In particular embodiments, a web server 16 may render a web page and then serve the rendered web page to a client 14 for display. When a web page renders, the browser or the server rendering the web page may retrieve one or more elements of the web page from one or more web servers 16 or ad servers 18. As an example, multiple web servers 16 operated by a single publisher may host elements of web pages of the publisher. For example, the publisher may operate one or more first web servers 16 for video, one or more second web servers 16 for text, one or more third web servers 16 for images, and one or more fourth web servers 16 for advertisements. Web servers 16 operated by the publisher may serve the domain of the publisher. In particular embodiments, an ad server 18 includes one or more servers or other computer systems for hosting advertisements for inclusion in web pages hosted by web servers 16. The present disclosure contemplates any suitable ad servers 18. Ad serving platforms for publishers operating ad servers 18, include, for example and without limitation, DOUBLECLICK DART for PUBLISHERS, or GOOGLE ADSENSE. A web page may include elements hosted by any combination of web servers 16 and ad servers 18. When a web browser at a client 14 renders a web page, the web browser may retrieve and load one or more elements of the web page from one or more web servers 16, as directed by one or more HTML or other files for rendering the web page. The web browser may retrieve and load one or more advertisements in the web page from one or more ad servers 16, similarly as directed by the HTML or other files for rendering the web page.

Ad indexing server 20 includes one or more computer servers or other computer systems, either centrally located or distributed among multiple locations, for indexing online advertisements, which may include collecting information about online advertisements (such as their attributes) and storing the information as advertisement data 24. In particular embodiments, ad indexing server 20 includes a hardware, software, or embedded logic components or a combination of two or more such components for carrying out such functionality. As an example and not by way of limitation, ad indexing server 20 may include an access engine 26, an object model engine 28, a rendering engine 30, one or more detector engines 32, and one or more analysis engines 34, which operate as described below.

Particular embodiments detect the location of online advertising across the Internet and provide information about the presence of ads on a website, the ad sizes and formats present, as well as the ad servers and networks that are serving ads. Particular embodiments may provide more comprehensive information about online ads on the Web, which may be valuable to advertisers using online advertisement tools (such as, for example and without limitation, GOOGLE AD PLANNER) to plan and manage their online advertising campaigns more effectively. Particular embodiments crawl and index as many advertisements and as much advertising inventory on the Internet as practicable. For each ad, particular embodiments may collect information such as the ad format (text/image/video/FLASH/gadget/etc.), size, style, page position, ad network, hosting web page, and perhaps the advertising vendor, as well as reach, frequency, and estimates of cost per thousand impressions (CPM). Online advertising tools such as GOOGLE AD PLANNER may use this information to allow their users to filter websites by advertising or networking type to target websites they are more likely to be interested in. This information may also help advertisers track their competitors and their ad campaigns and better direct their own online advertising campaigns. This information may also be used for market research, e.g., for discovering ad company size, ad company reach in different countries, ad company overlap, etc. This information may also be used to help detect the underselling of online advertisements. Particular embodiments are interested not only in actual advertisements, but also in ad spots in general. For each publisher, particular embodiments attempt to determine what ad sizes, ad styles, and ad formats (text, image, video, widget, etc.) the publisher supports, whether there are ads above or below the fold, and so on. For some uses, even one-bit information, such as information indicating whether a particular website carries ads, is useful for advertisers.

Access engine 26 includes a hardware, software, or embedded logic component or a combination of two more such components for accessing web pages for ad indexing server 20. Access engine 26 may access web pages in any suitable manner. As an example and not by way of limitation, access engine 26 may use a web crawler (such as GOOGLE GOOGLEBOT web crawler) to browse the World Wide Web and access web pages. Access engine 26 may “piggyback” on the results of a web crawl performed to build a searchable index of web pages for a search engine, such as GOOGLE SEARCH. As another example, access engine 26 may access web pages in a web cache or other store of web pages, such as a web cache created for use by a web accelerator, search engine, or web archives As another example, access engine 26 may capture web pages or advertisements on web pages in real time by using a network of web browsers running on virtual machines.

As another example of access engine 26 accessing web pages for ad indexing server 20, access engine 26 may receive web pages from web browsers at clients 14 actively used by a particular user base, preferably in a manner that preserves user anonymity in order to protect the privacy and personally identifiable information of users. Each web browser may communicate to access engine 26 web pages loaded by the web browser. The web browser may communicate to access engine 26 every web page loaded by the web browser. As an alternative, the web browser may communicate only a predetermined percentage of web pages (such as every third web page) loaded by the web browser. As another alternative, the web browser may communicate only the first visited web page of every website visited by a user of the web browser. To communicate a web page to access engine 26, a web browser may render the web page and communicate the web page as rendered to access engine 26. As an alternative, the web browser may build an object model (which may be a DOM tree or other object model) of the web page from one or more HTML files for rendering the web page and communicate the object model to access engine 26. As another alternative, the web browser may communicate the one or more HTML files for rendering the web page to access engine 26. As another alternative, the web browser may scan the web page for advertisements, analyze any detected advertisements, and communicate the results of the analysis to access engine 26. The web browser may include one or more detector engines 32 and one or more analysis engines 34 (which are described below) for scanning the web page and analyzing advertisements. In particular embodiments, the functionality for communicating web pages to access engine 20 is in the web browser itself. In particular embodiments, the functionality for communicating web pages to access engine 20 is in an add-on, a plug-in, or another extension to the web browser.

As another example of access engine 26 accessing web pages for ad indexing server 20, access engine 26 may receive web pages from network nodes (such as network gateways) connecting clients 14 to web servers 16 and ad servers 18. In particular embodiments, network nodes operated by an Internet service provider (ISP) may monitor web traffic to and from clients 14 served by the ISP and communicate web pages visited by users at clients 14 to access engine 26, in such a manner as to preserve user anonymity and individual user's personally identifiable information. In particular embodiments, a proxy server may similarly monitor web traffic through the proxy server. The present invention contemplates monitoring web traffic and communicating web pages to access engine 26 in any suitable manner. To communicate a web page to access engine 26, a network node may render the web page and communicate the web page as rendered to access engine 26. As an alternative, the network node may build an object model of the web page from one or more HTML files for rendering the web page and communicate the object model to access engine 26. As another alternative, the network node may communicate the one or more HTML files for rendering the web page to access engine 26. As another alternative, the network node may scan the web page for advertisements, analyze any detected advertisements, and communicate the results of the analysis to access engine 26. The network node may include one or more detector engines 32 and one or more analysis engines 34 (which are described below) for scanning the web page and analyzing advertisements.

In particular embodiments, to get a more complete picture of the online advertising landscape, access engine 26 may access web pages, e.g., obtain HTML documents, under varying circumstances, such as from different geographic locations, at different times of day, after visiting different websites and having collected various cookies, etc. Advertisers may use such signals to create usage profiles for location, sex, age, interests, etc., and provide targeted advertisements based on their profiles.

When access engine 26 accesses a web page, access engine 26 may communicate the web page to one or more other components of ad indexing server 20 for processing. As an example and not by way of limitation, access engine 26 may communicate the web page to object model engine 28, which may build an object model of the web page for advertisement detection and analysis. As another example, access engine 26 may communicate the web page to rendering engine 30, which may fully or partially render the web page, according to particular needs, for advertisement detection and analysis. As another example, if access engine 26 receives the web page in the form of an object model built remotely, access engine 26 may communicate the object model to one or more detector engines 32 for advertisement detection. As another example, if access engine 26 receives the web page as rendered remotely, access engine 26 may communicate the web page as rendered to one or more detector engines 32 for detector engines 32 for advertisement detection. As another example, if access engine 26 receives results of advertisement detection and analysis executed on a web page remotely, access engine 26 may communicate the results for storage as advertisement data 24.

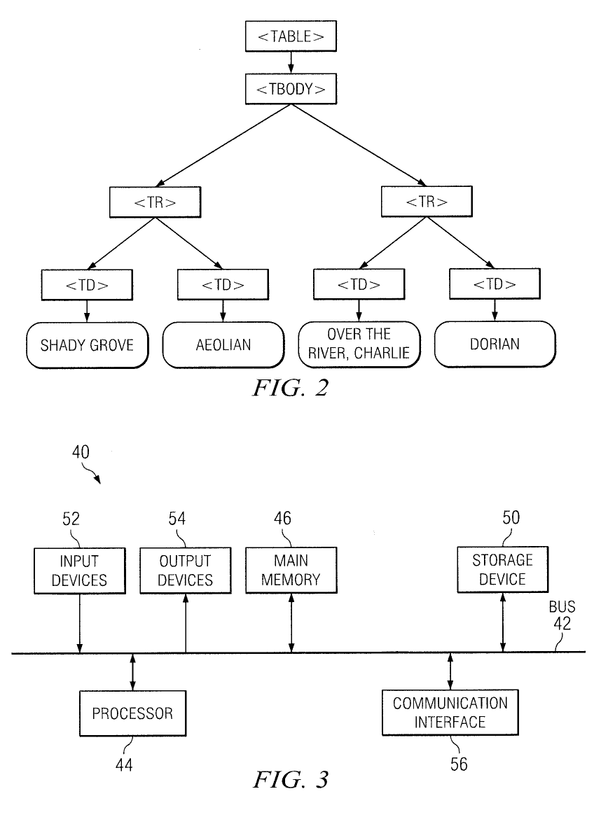

Object model engine 28 includes a hardware, software, or embedded logic component or a combination of two more such components for building object models of web pages for advertisement detection and analysis. In particular embodiments, an object model is a collection of descriptions of classes or interfaces, together with their member data, member functions, and class-static operations. In particular embodiments, object model engine 28 accesses an HTML file for rendering a web page and build a DOM tree of the web page. In particular embodiments, a DOM tree is a tree of nodes, with each node representing an element of the web page. As an example and not by way of limitation, one node of the DOM tree may represent a header on the web page, another node may represent the main text of the web page, another node may represent a navigation bar on the web page, and so on. FIG. 2 illustrates an example DOM tree. The DOM tree in FIG. 2 represents the following table from an HTML document:

<TABLE>
<TBODY>
<TR>
<TD>Shady Grove</TD>
<TD>Aeolian</TD>
</TR>
<TR>
<TD>Over the River, Charlie</TD>
<TD>Dorian</TD>
</TR>
</TBODY>
</TABLE>

In particular embodiments, a DOM is an application programming interface (API) for documents. It closely resembles the structure of the document it models. A DOM models documents using objects, and the model encompasses not only the structure of a document, but also the behavior of a document and the objects it includes. Herein, reference to an object in a document may encompass an element of the document, and vice versa, where appropriate. The nodes in the DOM tree in FIG. 2 do not necessarily represent a data structure; they represent objects which have functions and identities. As an object model, a DOM may identify the interfaces and the objects used to represent and manipulate a document; the semantics of the interfaces and the objects, including behavior and attributes; and the relationships and collaborations among the interfaces and the objects.

In particular embodiments, a DOM tree presents a document as a hierarchy of nodes that implement other specialized interfaces. Some nodes may have child nodes of various types, and others may be leaf nodes that cannot have anything below them in the document structure. In particular embodiments, for XML and HTML, the node types, and which node types they may have as children, are as follows:
Document—Element (maximum of one), ProcessingInstruction, Comment, DocumentType
DocumentFragment—Element, ProcessingInstruction, Comment, Text, CDATASection, EntityReference
DocumentType—no children
EntityReference—Element, ProcessingInstruction, Comment, Text, CDATASection, EntityReference
Element—Element, Text, Comment, ProcessingInstruction, CDATASection, EntityReference
Attr—Text, EntityReference
ProcessingInstruction—no children
Comment—no children
Text—no children
CDATASection—no children
Entity—Element, ProcessingInstruction, Comment, Text, CDATASection, EntityReference
Notation—no children

In particular embodiments, a document contains one or more elements having boundaries that are delimited by start-tags and end-tags or, for empty elements, by an empty-element tag. Each element has a type, identified by name, and may have a set of attributes. Each attribute has a name and a value.

Returning to FIG. 1, rendering engine 30 includes a hardware, software, or embedded logic component or a combination of two more such components for fully or partially rendering a web page. Dynamic analysis of a web page by one or more analysis engines 34 may require full or partial rendering of the web page, which rendering engine 30 may provide, according to particular needs. To render a web page, rendering engine 30 may retrieve and load one or more elements of the web page (such as, for example, JAVASCRIPT files, IFrames, images, etc.) from one or more web servers 16 or ad servers 18, as directed by one or more HTML or other files for rendering the web page. In particular embodiments, rendering engine 30 may use an object model of the web page generated by object model engine to render the web page. In particular embodiments, rendering engine 30 generates only headless renderings of web pages, since advertisement detection and analysis does not always require displaying the web pages to human users.

Detector engines 32 each include a hardware, software, or embedded logic component or a combination of two more such components for scanning web pages for advertisements. As an example and not by way of limitation, a detector engine 32 may access an object model of a web page and examine one or more elements of the web page using the object model to determine whether they are advertisements. In particular embodiments, the detection of an advertisement in a web page is heuristic, since it is often the case that no process can know for sure whether an element of a web page is an advertisement without having a human user look at a displayed rendering of the web page. To detect advertisements in web pages, particular embodiments use heuristics that rely in part on the sources of elements of the web pages. If an element includes link to a target URL or other destination, particular embodiments examine the target of the link.

Multiple detector engines 32 may scan a web page, with each detector engine 32 being capable of determining whether an element of the web page is an advertisement independent of other detector engines 32 scanning the web page. For example, the detector may recognize certain JAVASCRIPT snippets as representing an ad to be inserted, may recognize an image that fits the standard size and tags for a banner ad, or the detector may recognize the content of an IFrame of a rendered web page as matching the format and design of an advertisement. In addition or as an alternative, particular embodiments may use multiple determinations independently made by multiple detector engines 32 before finally determining whether an element of a web page is an advertisement. In particular embodiments, each detector engine 32 uses a unique algorithm for determining whether an element of a web page is an advertisement, basing its determination on unique criteria. As an example and not by way of limitation, a detector engine 32 may look for elements hosted by DOUBLECLICK ad servers 18. The source, e.g., the URL, of an element of a web page may be apparent in the object model of the web page. Elements hosted by DOUBLECLICK ad servers 18 are likely to be advertisements. First detector engine 32 may determine whether an element is hosted by a DOUBLECLICK ad server 18 by comparing the source of the element with a list of URLs, domains, or domain-name patterns known to correspond to DOUBLECLICK ad servers 18. One or more other detector engines 32 may similarly look for web page elements hosted by ad servers 18 operated by other ad serving companies. A detector engine 32 may have a rich collection of regular expressions that match known ad server domains and may flags ads (including images, IFrames, FLASH files, and JAVASCRIPT files) that originate from such domains as ads. In particular embodiments, a detector engine 32 may flag any element, text, image or otherwise, that is part of an <A HRE F> link to a known ad-redirector or other server that may track clicks on ads. Detector engine 32 may include or have access to a list of regular expressions matching a wide number of known ad redirectors. In particular embodiments, a detector engine 32 may flag any element that changes each time the page is reloaded, while remaining fixed in position and size, and heuristically deem the element not to be part of the key content of the web page. In particular embodiments, a detector engine 32 may flag any element that is part of an <A HREF> link, where the target of the link includes a randomized component generated using JAVASCRIPT code. In particular embodiments, one or more detector engines 32 each return a number indicating a confidence level. A mathematical formula may then be used by software at ad indexing server 20 (such as one or more other detector engines 32 or one or more analysis engines 34) to aggregate these confidence levels into a global confidence level for the whole web page, for the whole website, or both. Web pages or websites that have an aggregate confidence level higher than a particular threshold (which may be predetermined) may be deemed to contain ads.

As another example of a detector engine 32 using a unique algorithm for determining whether an element of a web page is an advertisement, a detector engine 32 may use a heuristic algorithm for detecting advertisements from unknown ad domains. If a web page originates from www.example.com and the web page embeds an image from ad.example.com, detector engine 32 may determine the image is an advertisement, even if the domain ad.example.com is not a known ad server domain. As another example, a detector engine 32 may scan web pages for “advertise here” links on a home page of a website or on internal web pages. Detector engine 32 may detect such links with support for multiple variations of the link text, such as “advertise with us,” “advertise on <website name>,” “your ad here,” etc., plus versions of the same in different languages. As another example, a detector engine 32 may look at the destinations of links in elements of web pages. If a user clicked on or otherwise selected an advertisement on a web page, the link in the advertisement would likely direct the web browser of the user to one or more redirection servers, which count clicks for charging advertisers, that redirect the web browser of the user to a URL of the advertiser. If a text fragment of a web page leads to a known ad-tracking or redirection server, detector engine 32 may determine the text is an advertisement, as opposed to a nonadvertisement link on the web page. The present disclosure contemplates any suitable detector engines 32 using any suitable algorithms or any suitable criteria for determining whether elements of web pages are advertisements.

In particular embodiments, if one or more detector engines 32 determines that an element of a web page is an advertisement, one or more analysis engines 34 analyze the advertisement to determine one or more attributes of the advertisement. As discussed above, attributes of an advertisement may include format (such as text, image, video, animation, gadget, etc.); size; web page position (such as top, left, above the fold, below the fold, etc.); inclusion method (such as being included in the HTML file for the web page, being in an IFrame in the HTML file, or being rendered by execution of a script); presentation mode (such as inline, pop-up, pop-under, pre-roll, etc.); destination URL (such as www.example.com, etc.); ad server (such as DOUBLECLICK, GOOGLE ADSENSE, etc.); expected click-through rate (eCTR); publisher; and advertiser. Online advertising campaigns (which may encompass multiple advertisements at multiple publishers) may have similar attributes.

Analysis engines 34 each include a hardware, software, or embedded logic component or a combination of two more such components for determining one or more attributes of an advertisement on a web page. An analysis engine 34 may be integral to or separate from one or more detection engines 32. Multiple analysis engines 34 may analyze an advertisement, with each analysis engine being capable of determining one or more particular attributes of the advertisement independent of other analysis engines 34 scanning the web page. In particular embodiments, each analysis engine 34 uses a unique algorithm for determining one or more attributes of an advertisement on a web page. As an example and not by way of limitation, an analysis engine 34 may determine one or more attributes of an advertisement on a web page through static analysis, e.g., without rendering the web page, without retrieving any elements of the web page outside the HTML file for the web page (such as IFrames), and without executing any scripts (such as JAVASCRIPT) in the web page. Analysis engine 34 may simply process the “raw” HTML of the web page. As another example, an analysis engine 34 may determine one or more attributes of an advertisement on a web page through dynamic analysis, with a rendering of the web page, retrieval of any elements of the web page outside the HTML file for the web page, and execution of any script in the web page. The rendering may be a headless rendering that generates a more accurate and richer HTML tree of the web page, which analysis engine 34 may analyze to determine more attributes of advertisements in the web page. Each analysis engine 34 may use a unique analysis algorithm for independently analyzing an advertisement. Moreover, each analysis engine 34 may be optimized for one or more particular methods of embedding advertisements, according to particular needs.

In particular embodiments, a complete HTML tree can be achieved only after some processing of the raw HTML, e.g., executing any JAVASCRIPT embedded in the page, executing any JAVASCRIPT loaded by the web page but not embedded in it, and loading any IFrames. Each IFrame is an HTML tree in its own right, embedded in the “main” HTML tree of the web page; deep recursion is possible with IFrames. Analysis is possible without obtaining the complete HTML tree, but the analysis will be less complete. Analysis of the raw HTML is “static” analysis, since it requires no fetching of additional data. Analysis of the complete HTML tree is “dynamic” analysis, since external JAVASCRIPT, IFrame, and image files must be fetched. As an example an not by way of limitation, with static analysis, if a detector engine 32 determines that a web page includes an IFrame or an external JAVASCRIPT file from a known ad server domain (or a heuristically detected ad server domain) and the IFrame or external JAVASCRIPT is therefore an advertisement, information about the ad type (image, text, etc.), ad size, and several other ad attributes may be unavailable. For dynamic analysis, particular embodiments must simulate the way a web browser builds a complete HTML tree of a web page. Particular embodiments may do this by running a modified version of a rendering engine (such as rendering engine 30) of a real web browser, so that the tree is built but nothing is displayed, as with a headless rendering. As an alternative, particular embodiments may run a browser in a virtual machine (where the page renders but the display output is discarded) or using a “fake” video driver or video server, such as X Virtual Frame Buffer (XVFB).

To determine one or more attributes of an advertisement, an analysis engine 34 may analyze the advertisement itself for extracting additional data, including the ad size and destination URLs (in FLASH ads). An analysis engine 34 may extract text from the advertisement (which may be possible for text ads and for FLASH ads with text and may, with the use of optical character recognition (OCR), be possible for images and FLASH ads). Analysis engine 34 may use the extracted text to find URLs and domain names, as well as keywords that are relevant for analyzing, classifying or understanding the ad.

In particular embodiments, static analysis may involve scanning a web cache for ad servers 18 present in each website based on server-specific HTML patterns. Such analysis may determine ad server and ad size for advertisements on web pages in the web cache. In particular embodiments, such analysis may sometimes identify advertisers, but rarely identify specific advertising campaigns. In particular embodiments, static analysis may involve scanning the clickstreams of web browser add-ons, plug-ins, or other extensions, such as GOOGLE TOOLBAR. As an example, a pattern in a log may indicate that a user on web page P is directed (via a link) to web page S. Web page S may be a known redirection server for an ad-serving domain (such as ads.DOUBLECLICK.com) and may redirect the user to website A. Static analysis by an analysis engine 34 may therefore determine that P is a publisher running ads for advertiser A in server S. Scanning the clickstreams of web browser extensions may also enable determination of the CTR of a publisher, but not necessarily the CTR of ads or ad servers 18, since static analysis does not indicate which ads were shown.

In particular embodiments, server-side dynamic analysis may use a farm of computer systems running browsers in virtual machines. Such analysis may provide exact ad size and location. Particular embodiments may avoid following links in advertisements in web pages, as doing so may generate click spam. In particular embodiments, client-side dynamic analysis may use ad detection and reporting features in web browser add-ons, plug-ins, or other extensions. Such analysis may enable determination of CTR by counting the relative numbers of clicks by users. To determine advertiser or ad campaign, OCR may result in negative performance impact at the client machine, but the client machine may report an image hash for comparison to images of known advertisements.

In particular embodiments, ad indexing server 20 may aggregate data about advertisements by website. As an example and not by way of limitation, ad indexing server 20 may analyze web pages of a website as described above and then generate statistics across the web pages for the website in general. Such statistics may include “website A has an average of X advertisements per web page, Y percent of the advertisements use Z ad servers, and the distribution between the ad servers is M percent DOUBLECLICK and N percent GOOGLE ADSENSE. The present invention contemplates any suitable statistics. In particular embodiments, aggregating data about advertisements by website may facilitate detection of false positives indicating web page elements are advertisements, when in fact they are not. As an example and not by way of limitation, if a website includes a large number of web pages and very few of the web page have elements that detector engines 32 are flagging as advertisements, detectors engines 32 may be generating false positives across the website, which may occur on a discussion board website, where users occasionally post links and the posted links are rarely advertisements. Ad indexing server 20 may include one or more aggregation engines, which may include one or more hardware, software, or embedded logic components for aggregating data about advertisements by website.

As discussed above, a detector engine 32 may determine whether an element is an advertisement by determining whether the element includes a link to an ad server. A webmaster or web designer may want to track how users use specific links in a website. As an example and not by way of limitation, a website may have an “about us” link at the bottom of every web page. The website may include a mechanism for tracking clicks on those links, but the mechanism may be similar to mechanisms for tracking clicks on advertisements. A detector engine 32 may determine that many (or even all) web pages of a web site have the same link with the same text and therefore determine that the element is not an advertisement, but a link that the website is tracking internally. This is another example of a potential false positive indicating web page elements are advertisements when in fact they are not. Aggregating data about advertisements across a website may help reduce the occurrence of such false positives.

FIG. 3 illustrates an example architecture 40 for an example computer system. In particular embodiments, clients 14, web servers 16, ad servers 18, and ad indexing server 20 may each include one or more suitable computer systems for carrying out their respective functionality. Although FIG. 3 illustrates a particular architecture 40, clients 14, web servers 16, ad servers 18, and ad indexing server 20 may include any suitable architectures for carrying out their respective functionality. Architecture 40 may include one or more buses 42, one or more processors 44, main memory 46, a mass storage device 50, one or more input devices 52, one or more output devices 54, and one or more communication interfaces 56. Bus 42 may include one or more conductors (such as for example copper traces in a printed circuit board (PCB)) providing electrical paths between or among components of the computer system enabling the components to communicate with each other. In addition or as an alternative, bus 42 may include one or more fibers providing optical paths between or among components of the computer system enabling the components to communication with each other. A motherboard and one or more daughterboards may provide one or more portions of bus 42. One or more peripheral buses for expansions to the motherboard or the daughterboards may provide one or more other portions of bus 42. The present disclosure encompasses any suitable bus 42.

Processor 44 may include any suitable processor or microprocessor for interpreting and executing instructions. As an example and not by way of limitation, processor 44 may include an integrated circuit (IC) containing a central processing unit (CPU) with one or more processing cores. Main memory 46 may include volatile or other memory directly accessible to processor 44 for storing instructions or data that processor 44 is currently executing or using. As an example and not by way of limitation, main memory 46 may include one or more ICs containing random access memory (RAM), such as dynamic RAM (DRAM) or static RAM (SRAM). Mass storage device 50 may include persistent memory for storing instructions or data for execution or use by processor 44. As an example and not by way of limitation, mass storage device 50 may include one or more hard disk drives (HDDs) for storing firmware, an operating system (OS), and software for applications that the OS may host for the computer system. Example applications that may run at the computer system include a web browser or a sniffer, which may analyze data packets received by the computer system. One or more of the HDDs may be magnetic or optical, according to particular needs. Mass storage device 50 may include one or more drives for removable optical or magnetic discs, such as compact disc read-only memory (CD-ROM).

Input devices 52 may include one or more devices enabling a user to provide input to the computer system. Example input devices 52 include a keyboard and a mouse. The present disclosure contemplates any suitable combination of any suitable input devices 52. Output devices 54 may include one or more devices for providing output to a user. Example output devices include a monitor, speakers, and a printer. The present disclosure contemplates any suitable combination of any suitable output devices 54. Communication interface 56 may include one or more components enabling the computer system to communicate with other computer systems. As an example and not by way of limitation, communication interface 56 may include one or more components for communicating with another computer system via network 12 or one or more links 22.

As an example and not by way of limitation, the computer system having architecture 40 may provide functionality as a result of processor 44 executing software embodied in one or more tangible, computer-readable media, such as main memory 46. A computer-readable medium may include one or more memory devices, according to particular needs. Main memory 46 may read the software from one or more other computer-readable media, such as mass storage device 50 or from one or more other sources via communication interface 56. The software may cause processor 44 to execute particular processes or particular steps of particular processes described herein. In addition or as an alternative, the computer system may provide functionality as a result of logic hardwired or otherwise embodied in a circuit, which may operate in place of or together with software to execute particular processes or particular steps of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

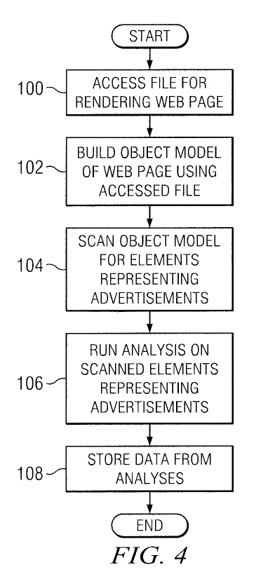

FIG. 4 illustrates an example method for indexing online advertisements. The method begins at step 100, where access engine 26 accesses a file for rendering a web page. As described above, access engine 26 may access web pages in any suitable manner. As an example and not by way of limitation, access engine 26 may use a web crawler (such as GOOGLEBOT) to browse the World Wide Web and access web pages. Access engine 26 may “piggyback” on the results of a web crawl performed to build a searchable index of web pages for a search engine, such as GOOGLE SEARCH. As another example, access engine 26 may access web pages in a web cache or other store of web pages, such as a web cache created for use by a web accelerator. As another example, access engine 26 may capture web pages or advertisements on web pages in real time by using a farm of web browsers running on virtual machines. At step 102, object model engine 28 builds an object model of the web page. As described above, the object model may be a DOM tree of the web page. At step 104, one or more detector engines 32 scan the object model for elements that represent advertisements. As described above, multiple detector engines 32 may scan a web page, with each detector engine 32 being capable of determining whether an element of the web page is an advertisement independent of other detector engines 32 scanning the web page. In addition or as an alternative, particular embodiments may use multiple determinations independently made by multiple detector engines 32 before finally determining whether an element of a web page is an advertisement. In particular embodiments, each detector engine 32 uses a unique algorithm for determining whether an element of a web page is an advertisement, basing its determination on unique criteria.

At step 106, one or more analysis engines 34 analyze the scanned elements that represent advertisements to determine one or more attributes of the advertisements. As described above, an analysis engine 34 may determine one or more attributes of an advertisement on a web page through static analysis, e.g., without rendering the web page, without retrieving any elements of the web page outside the HTML file for the web page (such as IFrames), and without executing any scripts (such as JAVASCRIPT) in the web page. In addition or as an alternative, an analysis engine 34 may determine one or more attributes of an advertisement on a web page through dynamic analysis, with a rendering of the web page, retrieval of any elements of the web page outside the HTML file for the web page, and execution of any script in the web page. The rendering may be a headless rendering. At step 108, ad indexing server 20 stores the results of the analyses as advertising data, at which point the method ends. The method illustrated in FIG. 3 may repeat for multiple web pages across multiple websites to build a more comprehensive index of online advertisements, according to particular needs. Although particular components of system 10 are described as carrying out particular steps of the method of FIG. 3, the present invention contemplates any suitable components carrying out any suitable steps of the method of FIG. 3. Moreover, although particular steps of the method of FIG. 3 are described and illustrates as occurring in a particular order, the present invention contemplates any suitable steps of the method of FIG. 3 occurring in any suitable order.

The present disclosure encompasses all changes, substitutions, variations, alterations, and modifications to the example embodiments described herein that a person having ordinary skill in the art would comprehend. Similarly, where appropriate, the appended claims encompass all changes, substitutions, variations, alterations, and modifications to the example embodiments described herein that a person having ordinary skill in the art would comprehend.

What is claimed is:

1. A method for a detection server in communication with each of a plurality of web pages of a plurality of websites on a plurality of web servers, the detection server in communication with an ad indexing server, comprising:
automatically accessing from the detection server a file for rendering the web page from a web server, the web page comprising one or more elements;
automatically building an object model of the web page at the detection server using the accessed file, the object model comprising nodes representing the elements of the web page;
automatically scanning the object model at the detection server for one or more elements that are advertisements;
automatically analyzing each scanned advertisement at the detection server to determine one or more attributes of the scanned advertisement; and
automatically storing data at the ad indexing server on the determined attributes of the scanned advertisements found at the detection server to facilitate an indexing of advertisements on the plurality of web pages of the plurality of websites.

2. The method of claim 1, wherein the file is a Hypertext Markup Language (HTML) file or an Extensible Markup Language (XML) file.

3. The method of claim 1, wherein automatically accessing the file comprises crawling one or more portions of the World Wide Web to access the file.

4. The method of claim 1, wherein automatically accessing the file comprises crawling a cache of a plurality of web pages of a plurality of websites to access the file.

5. The method of claim 1, wherein automatically accessing the file comprises receiving the file from a client loading the web page for a user.

6. The method of claim 5, wherein receiving the file from a client loading the web page for a user comprises receiving the file from software executing at the client operable to monitor, receive, or process web traffic to the client.

7. The method of claim 1, wherein automatically accessing the file comprises automatically receiving the file from a network node in a network path between a client requesting the web page and a server communicating one or more elements of the web page to the client.

8. The method of claim 7, wherein receiving the file from the network node comprises receiving the file from software executing at the network node operable to monitor, receive, or process web traffic.

9. The method of claim 1, wherein elements of the web page comprise static text, static images, animated images, audio, video, interactive text, interactive illustrations, buttons, hyperlinks, forms, meta elements, scripts, or inline frames (IFrames).

10. The method of claim 1, wherein the object model comprises a Document Object Model (DOM) tree.

11. The method of claim 1, wherein analyzing a scanned advertisement comprises analyzing the scanned advertisement without rendering the web page.

12. The method of claim 1, wherein analyzing a scanned advertisement comprises rendering of one or more portions of the web page and using the rendering to analyze the scanned advertisement.

13. The method of claim 1, wherein analyzing a scanned advertisement comprises analyzing the scanned advertisement without executing any scripts in the file for rendering web page.

14. The method of claim 1, wherein analyzing a scanned advertisement comprises executing one or more scripts in the file for rendering the web page and using output of the executed scripts to analyze the scanned advertisement.

15. The method of claim 1, wherein analyzing a scanned advertisement comprises analyzing the scanned advertisement without loading any inline frames in the file for rendering web page.

16. The method of claim 1, wherein analyzing a scanned advertisement comprises loading one or more inline frames in the file for rendering the web page and using the loaded inline frames to analyze the scanned advertisement.

17. The method of claim 1, wherein scanning the object model comprises using one or more independent detector engines to scan the object model, each independent detector engine comprising one or more unique detection algorithms for independently detecting advertisements.

18. The method of claim 17, wherein one of the unique detection algorithms detects advertisements by detecting links to remote servers known to host advertisements.

19. The method of claim 1, wherein analyzing one of the scanned advertisements comprises using one or more independent analysis engines to analyze the scanned advertisement, each independent analysis engine comprising one or more unique analysis algorithms for independently analyzing the advertisement to determine one or more attributes of the scanned advertisement, each independent analysis engine being optimized for one or more particular methods of embedding advertisements.

20. The method of claim 1, wherein an attribute of a scanned advertisement comprises format, position, method of embedding, presentation mode, size, vendor, or host.

21. The method of claim 1, further comprising automatically aggregating the stored data on the determined attributes of the scanned advertisements with data from a plurality of web pages of a particular website to facilitate generating statistics on advertisements across the particular website.

22. The method of claim 1, further comprising automatically accessing the file a plurality of times under varying circumstances.

23. The method of claim 22, wherein the varying circumstances comprise accessing the file at various times of day, accessing the file from various geographic locations, or accessing the file after collecting various cookies from various other web pages.

24. An apparatus comprising:
an access engine that automatically accesses, for each of a plurality of web pages of a plurality of websites, a file for rendering the web page, the web page comprising one or more elements;
an object model engine that automatically builds an object model of the web page using the accessed file, the object model comprising nodes representing the elements of the web page;
one or more detector engines that automatically scan the object model for one or more elements that are advertisements;
one or more analysis engines that automatically analyze each scanned advertisement to determine one or more attributes of the scanned advertisement; and
memory that automatically stores data on the determined attributes of the scanned advertisements to facilitate an indexing of advertisements on the plurality of web pages of the plurality of websites.

25. The apparatus of claim 24, wherein the file is a Hypertext Markup Language (HTML) file or an Extensible Markup Language (XML) file.

26. The apparatus of claim 24, wherein automatically accessing the file comprises automatically crawling one or more portions of the World Wide Web to automatically access the file.

27. The apparatus of claim 24, wherein automatically accessing the file comprises crawling a cache of a plurality of web pages of a plurality of websites to automatically access the file.

28. The apparatus of claim 24, wherein automatically accessing the file comprises automatically receiving the file from a client loading the web page for a user.

29. The apparatus of claim 28, wherein receiving the file from a client loading the web page for a user comprises receiving the file from software executing at the client operable to monitor, receive, or process web traffic to the client.

30. The apparatus of claim 24, wherein automatically accessing the file comprises automatically receiving the file from a network node in a network path between a client requesting the web page and a server communicating one or more elements of the web page to the client.

31. The apparatus of claim 30, wherein receiving the file from the network node comprises receiving the file from software executing at the network node operable to monitor, receive, or process web traffic.

32. The apparatus of claim 24, wherein elements of the web page comprise static text, static images, animated images, audio, video, interactive text, interactive illustrations, buttons, hyperlinks, forms, meta elements, scripts, or inline frames (IFrames).

33. The apparatus of claim 24, wherein the object model comprises a Document Object Model (DOM) tree.

34. The apparatus of claim 24, wherein analyzing a scanned advertisement comprises analyzing the scanned advertisement without rendering the web page.

35. The apparatus of claim 24, wherein analyzing a scanned advertisement comprises rendering of one or more portions of the web page and using the rendering to analyze the scanned advertisement.

36. The apparatus of claim 24, wherein analyzing a scanned advertisement comprises analyzing the scanned advertisement without executing any scripts in the file for rendering web page.

37. The apparatus of claim 24, wherein analyzing a scanned advertisement comprises executing one or more scripts in the file for rendering the web page and using output of the executed scripts to analyze the scanned advertisement.

38. The apparatus of claim 24, wherein analyzing a scanned advertisement comprises analyzing the scanned advertisement without loading any inline frames in the file for rendering web page.

39. The apparatus of claim 24, wherein analyzing a scanned advertisement comprises loading one or more inline frames in the file for rendering the web page and using the loaded inline frames to analyze the scanned advertisement.

40. The apparatus of claim 24, wherein the independent detector engines each scan the object model using a unique detection algorithm for independently detecting advertisements.

41. The apparatus of claim 40, wherein one of the unique detection algorithms detects advertisements by detecting links to remote servers known to host advertisements.

42. The apparatus of claim 24, wherein the independent analysis engines each analyze a scanned advertisement using a unique analysis algorithm for independently analyzing the advertisement to determine one or more attributes of the scanned advertisement, each independent analysis each being optimized for one or more particular methods of embedding advertisements.

43. The apparatus of claim 24, wherein an attribute of a scanned advertisement comprises format, position, method of embedding, presentation mode, size, vendor, or host.

44. The apparatus of claim 24, further comprising an aggregation engine that automatically aggregates the stored data on the determined attributes of the scanned advertisements with data from a plurality of web pages of a particular website to facilitate generating statistics on advertisements across the particular website.

45. The apparatus of claim 24, wherein the access engine automatically accesses the file a plurality of times under varying circumstances.

46. The apparatus of claim 45, wherein the varying circumstances comprise accessing the file at various times of day, accessing the file from various geographic locations, or accessing the file after collecting various cookies from various other web pages.

47. A system comprising:
means for accessing, for each of a plurality of web pages of a plurality of websites, a file for rendering the web page, the web page comprising one or more elements;
means for building an object model of the web page using the accessed file, the object model comprising nodes representing the elements of the web page;
means for scanning the object model for one or more elements that are advertisements;
means for analyzing each scanned advertisement to determine one or more attributes of the scanned advertisement; and
means for storing data on the determined attributes of the scanned advertisements to facilitate an indexing of advertisements on the plurality of web pages of the plurality of websites.
